(19) United States
(12) Patent Application Publication
(10) Pub. No.: US 2019/0280605 A1
(43) Pub. Date: Sep. 12, 2019

(54) Bidirectional DC DC Converter for Renewable Energy Storage

(71) Applicants: Eugene F. Krzywinski, San Jose, CA (US); William B. Reed, San Jose, CA (US); James A. Allen, JR., Gilroy, CA (US)

(72) Inventors: Eugene F. Krzywinski, San Jose, CA (US); William B. Reed, San Jose, CA (US); James A. Allen, JR., Gilroy, CA (US)

(21) Appl. No.: 16/297,619

(22) Filed: Mar. 9, 2019

Related U.S. Application Data
(60) Provisional application No. 62/641,197, filed on Mar. 9, 2018.

(51) Int. Cl. H02M 3/335; H02J 3/38; H02J 3/32

(52) U.S. Cl. CPC H02M 3/33584; H02J 3/32; H02J 3/385; H02M 3/33592

(57) ABSTRACT

This disclosure describes a unique bidirectional DC DC converter that transfers power between a high voltage source, such as the DC voltage in a solar PV array, a low voltage energy storage element such as a battery pack, and an inverter that is controlling the operating voltage of the solar PV array. Its novelty is that it is transparent to the inverter's control mechanism and is perceived as a source equivalent to the existing solar PV. By controlling the charge and discharge times of the energy storage element, the solar power that is harvested during the sun hour day can be metered back to the inverter at more optimal times, either for self consumption or to take advantage of higher rates of power sold to a connected utility. The bidirectional DC DC converter is unique in its operation in that it utilizes synchronous rectification when down-converting higher voltages to lower voltages and in that it uses high speed Silicon Carbide, or Gallium Nitride devices necessary for such rectification. Another unique aspect is the variable overlapping of the drive signal of the switches in the boost (second) stage of the converter which allows for a continuous range of voltage levels of the transferred power from energy storage element to the primary stage and output.

### CROSS REFERENCE TO RELATED APPLICATIONS

This application claims the benefit of U.S. Provisional Application No. 62/641,197 “DC DC Converter with MPPT and Transfer Switch” filed on Mar. 9, 2018, the entirety of which is incorporated herein by this reference thereto.

### TECHNICAL FIELD OF THE INVENTION

The invention relates to bidirectional DC DC converters between sources, loads and energy storage devices.

### BACKGROUND

Solar power in the US is primarily grid tied to avail the owner of net metering provisions offered by the local utility. In many instances, net metering provisions are under going change which decreases the net metering credit to the owner by changing the on-peak hours, when net metering credits are of highest value, to later times when power feed from the owner to the grid is more valuable to the utility. The power to be fed back is dependent on the sun's profile, not time, and so maximum solar energy harvest is now out of sync with utility demand. To accommodate this change, the solar system can be equipped with an energy storage component, such as a battery, that stores the energy harvested at peak solar production and then releases it to the grid, or the homeowner, during the new on-peak hours, thereby benefiting both the utility grid and the owner of the solar system.

Solar systems deployed over the past several years were provisioned primarily for net metering and storage was not contemplated. As such, retrofitting the solar system with storage or additional power inputs is a difficult and engineering intensive, costly task. The invention reduces the cost and effort of retrofitting such solar arrays, as well as significantly reducing the engineering required to effect such a change.

### CURRENT STATE OF THE ART

Current state of the art for adding energy storage to an existing solar PV installation includes replacing the current inverter with an inverter configured to connect to a battery system, or to include an inverter within each battery pack. In addition, either dedicated load circuits or transfer switches must be used to be able to provide self consumption on-site.

Batteries present a fixed (or limited range) voltage which makes adding their DC voltage to a PV DC voltage buss impractical because of the very wide variability of the PV system voltage. And, since each system has different PV configurations, a one-size fits all solution has not been realizable.

The market growth of energy storage systems for renewable energy applications continues to grow exponentially, although for new installations primarily. The invention provides a solution for both new installations and for retrofitting existing with energy storage.

### SUMMARY OF THE INVENTION

The invention provides an electrical adapter between renewable energy sources and loads such that energy storage elements can be added to the system with minimal effort and disruption. In one embodiment, the invention is inserted into an existing solar energy system that consists of a photovoltaic array connected to a grid tied inverter and where it is desired to add an energy storage element to said system. Such energy storage systems have a duality in that they are both loads (charging) and sources (discharging) and must match the system's electrical characteristics in order to function properly. Typically, such existing systems have high DC voltage magnitudes that are incompatible with low DC voltage magnitude energy storage elements and therefore a voltage converter is required to adapt the storage element to the array. Photovoltaic arrays need maximum power point tracking (MPPT) elements to ensure maximum power harvesting from the array and this function is typically provided by the load, in most cases a grid tied inverter. During the charge phase of the energy storage system, the existing load which typically provides the MPPT function remains operational as designed and the invention routes a configurable amount of the power to the battery to be charged. During the discharge phase, the converter must match the input characteristics of the load so that to the load it simply appears as a PV source, thereby allowing optimum blending of battery energy and maximum power PV energy to be presented to the load.

The invention combines the MPPT-following function, the voltage conversion function, the intelligent transfer function, with intelligent electronics for control of operation, either preprogrammed or user adjustable. In an embodiment, the invention also provides the charge control function for energy storage systems such as batteries and can interface to the battery's management system for optimal control and operation. In an embodiment, detailed operational data is collected by the invention and transmitted to a collection system that provides such data to the system owner or operator. In another embodiment, additional energy can be provided through the apparatus from an AC power source such as the utility grid, microgrids or AC generating equipment. In another embodiment, a secondary off-grid inverter can be connected to the system providing power to dedicated, critical loads when the primary, grid tied inverter is off-line.

### BRIEF DESCRIPTION OF THE DRAWINGS

FIG. 1 is a block diagram representing an embodiment of the invention showing the location of the invention with respect to the solar PV array and the DC AC inverter.

FIG. 2 is a functional diagram of the control section of an embodiment of the invention.

FIG. 3 is a schematic overview illustrating an embodiment of the invention with the primary and secondary sides.

FIG. 4 is a schematic of an embodiment of the invention with component details.

FIG. 5 is a schematic of an embodiment of the invention illustrating the timing diagram of the secondary side.

FIG. 6 is a block diagram of an embodiment of the invention illustrating additional elements to the base configuration.

FIG. 7 is a flowchart of the algorithm for an embodiment of the invention.

### DETAILED DESCRIPTION OF THE INVENTION

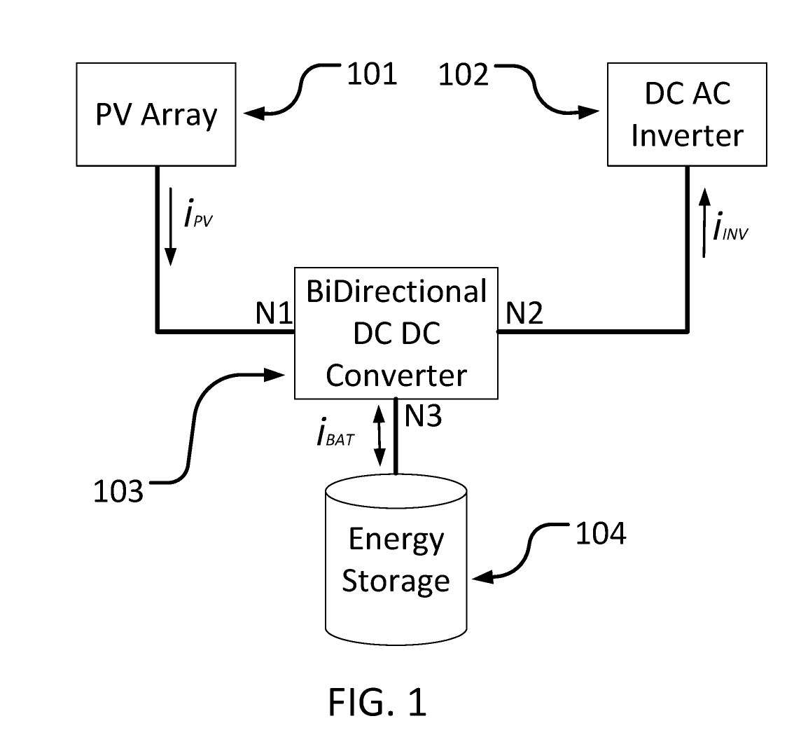

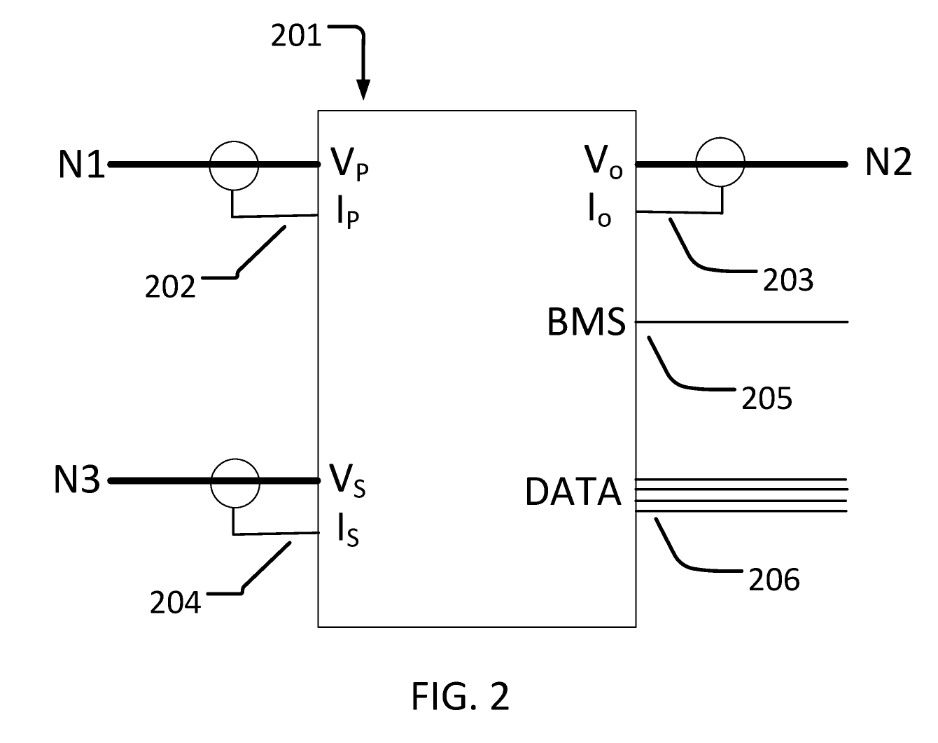

FIG. 1 shows an embodiment of the invention and where it is positioned between the energy source [101] PV array and the grid tied inverter [102]. The PV array [101] outputs power as the product of voltage and current and connects to N1 [202] of the DC DC Converter [103]. The controller [FIG. 2] measures the current and voltage at N1 [202] and the controller's algorithm determines the power flow and ratios between attached storage [104] and the grid tied inverter [102]. The controller [FIG. 2] also monitors the voltage and current at node 2, N2 [203] to determine the operating parameters of the DC DC converter. The controller [FIG. 2] also receives information from external sources such as the battery BMS [205] and business rules from the user via data lines [206] to determine if correct ratios are being applied to both the power flow and energy storage. By measuring the node currents and node voltages, the controller [FIG. 2] will determine the PV system maximum power point for all insolation conditions in both battery charge or discharge modes. In an embodiment of the invention, N1 and N2 can be the same physical connection point, eliminating the need for transfer switches.

During daylight, when the PV array [101] is energized and harvesting energy, its maximum power point (MPP) will vary considerably depending on irradiance, temperature, PV-module mismatch and soiling, shading and other external factors. The inverter [102] contains a maximum power point tracking (MPPT) algorithm to adjust the input voltage to match that of the PV-modules. The variance in MPP points can range from tens to hundreds of volts, preventing the insertion of fixed voltage batteries. In an embodiment of the invention, the converter automatically adjusts its N1 and N2 operating point to match the MPPT point established by the inverter [102] so that maximum energy harvesting from the PV array [101] is undisturbed and the converter [103] is transparent to the PV array [101] and the inverter [102] while they are operating.

As the PV array [101] harvests energy, the user can set business rules via the controller's [201] data lines [206] to specify when energy will be stored, how much of that energy harvest will be stored, and how much will be assigned to the inverter. Similar business rules are assigned to when the stored energy will be discharged and in what ratio. This operation provides the user with the ability to time shift the use or sale of energy harvested by the system to its most advantageous time.

The controller [201] also receives data from the battery's Battery Management System (BMS) [205] to determine the State of Charge (SOC), State of Health (SOH), the charge rate (C) and the discharge rate (C) defined by the user or by the battery manufacturer. In this respect, the converter performs as a charge controller and by measuring voltage and current at node 3, N3 [204] and using data input by the user, virtually any battery chemistry charge/discharge profile can be used, making the system agnostic to battery technologies and chemistries.

When operating in discharge mode, the controller [201] monitors voltages and currents at node N1 [202] and N2 [203] and executes its discharge operation to match the operational characteristics and MPPT of the PV array [101] and inverter [102]. The timing, the amount of power and its rate of discharge are governed by the controller [201]. A key feature of the controller [201] is the monitoring of the node voltages and currents, so the converter [103] continuously adjusts its output voltage and current to prevent current backflow from the energy storage [104] to the PV array [101], while still maintaining an optimal voltage at node 2, N2 [203] for the inverter's [102] operation.

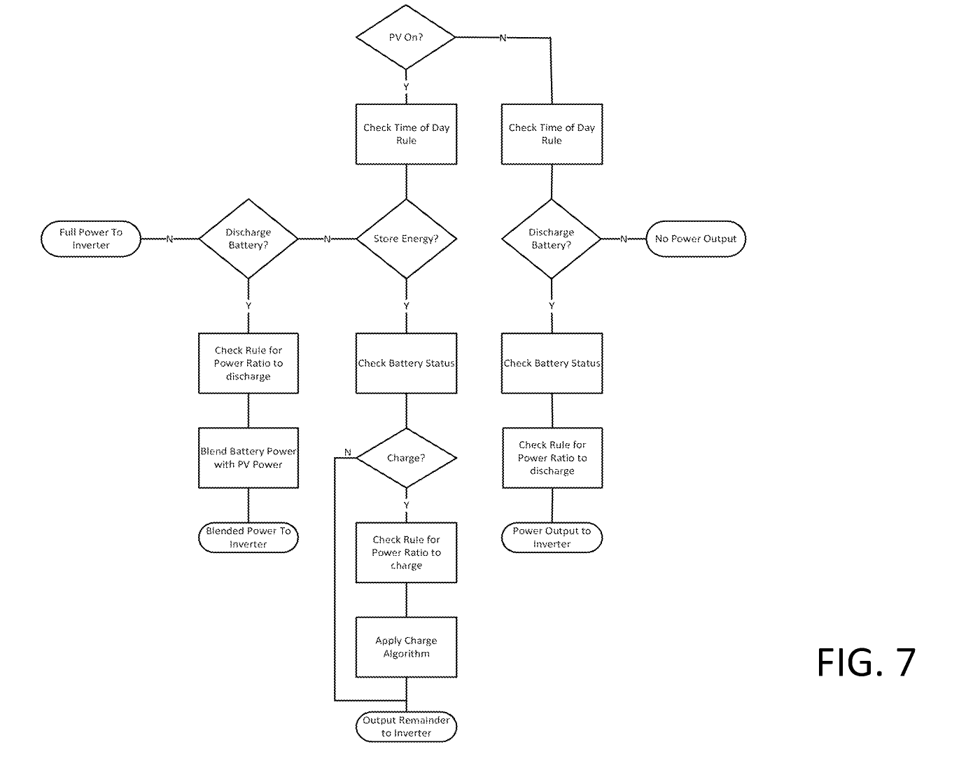

In an embodiment of the invention, the operating parameters and their execution are governed by a combination of electronic control circuitry and business rules established by a user. An example of these business rules and operation is shown in FIG. 7, operational algorithm flowchart. The flowchart parameters can be modified according to a user's requirements or those of the utility to which the system may be attached.

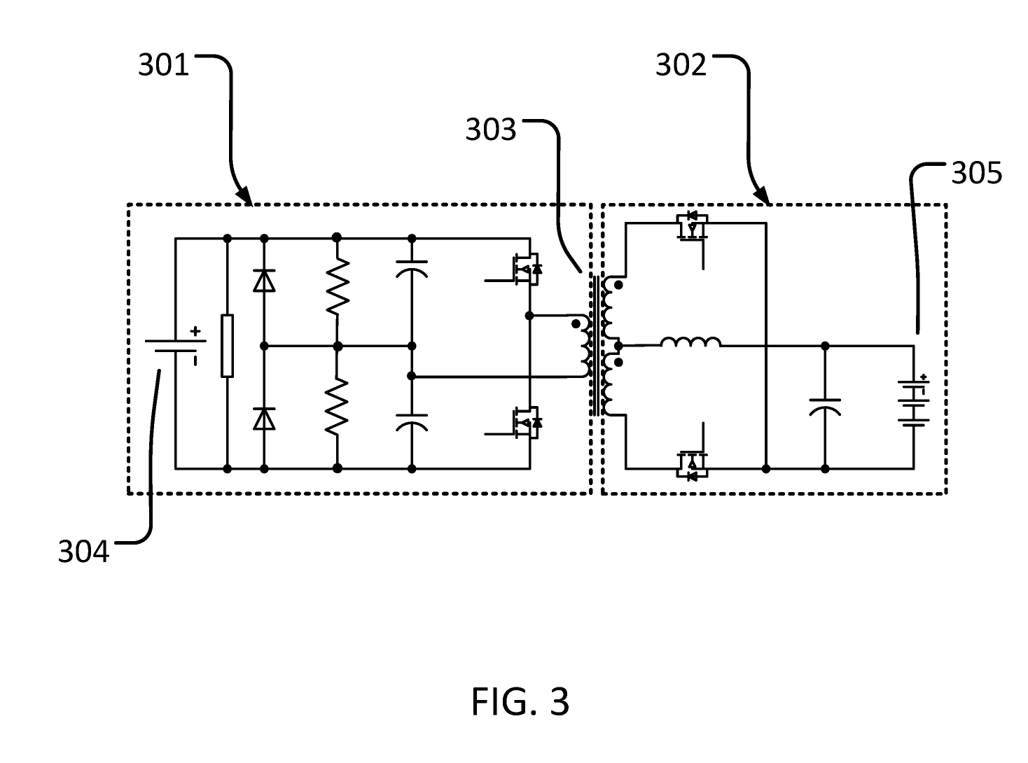

While many of the operational functions are handled by the controller [201] and its operational algorithm, the electrical properties of the converter [103], which make the system functional, reside in an innovative bidirectional DC DC converter shown in FIG. 3 In an embodiment of the invention, the DC DC converter consists of two sections magnetically coupled with a transformer [303]. The primary section [301] consists of a half bridge switching network designated as a high voltage side [304] and a secondary section [302] designated as a low voltage side [305]. In an embodiment of the invention, the primary section [301] connects to nodes N1 [202] and N2 [203] and to the primary terminals of the transformer [303]. The secondary section [302] is magnetically coupled via the transformer [303] to the primary section [301] and to the energy storage [305]. The converter is designed to operate bidirectionally. In the energy charge mode, the energy is received from a high voltage source [304] and down-converted to a low voltage suitable to the energy storage device [305]. In the energy discharge mode, the energy is received from the energy storage [305] and upconverted to a high voltage that matches the voltage at node 1 [202] and node 2 [203].

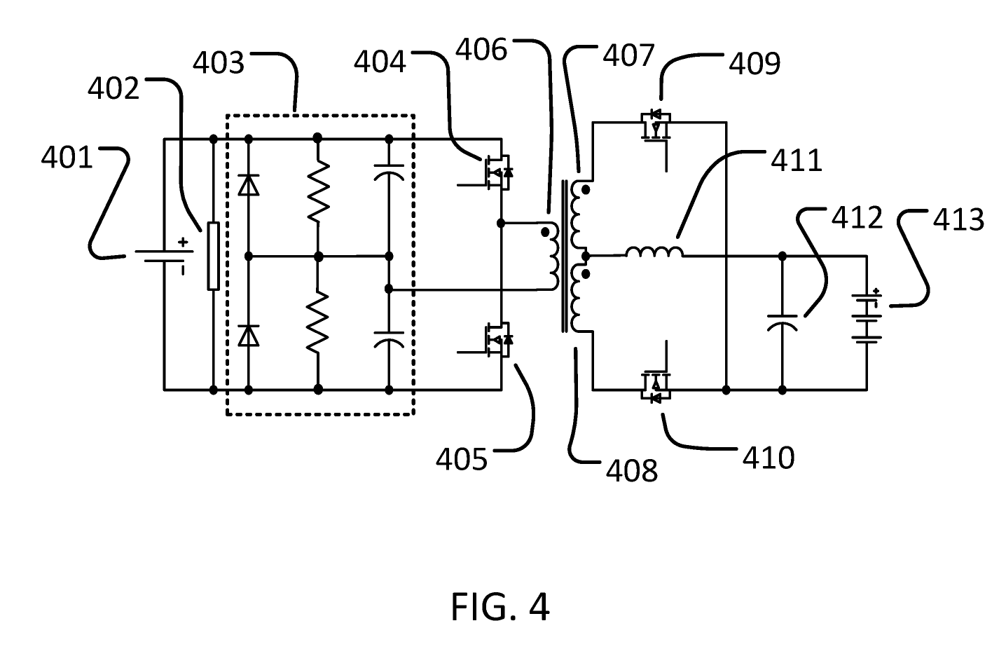

An embodiment of the invention is shown in FIG. 4. In the charging mode, a high voltage power from the PV array [101] is presented at [401]. This input combination of voltage and current is processed through a network of input filtering [302] and voltage balancing [303]. Switches [404] and [405] operate 180 degrees out of phase to each other to generate an AC signal across the terminals of the primary winding [406] of the magnetically coupled transformer [408]. The secondary windings [407] are alternately discharged in a push-pull operation via switches [409] and 410] to rectify the AC signal received through the windings. An inductor, [411] and capacitor [412] filter the signal to remove ripple and present a stable voltage to the energy storage [413]. A typical ratio of high to low voltage is in the range of 4:1 to 6:1. In an embodiment of the invention, the rectification on the low voltage side is through synchronous switching of the switches [409] and [410]. High speed switches and innovative control circuitry is necessary to achieve a continuously variable voltage, rather than quantized voltage steps normal for diode based rectification and which would make similar circuits unsuitable for this use.

In discharge mode of this embodiment of the invention, the power flow is reversed using the energy stored in the energy storage [413]. The secondary side [302] is now operated as a DC DC boost converter through charging and discharging the inductor [411] with switches [409] and [410] which produce an amplitude approximately half the value desired on the high voltage side. The windings [407] of the transformer [408] magnetically couple the AC signal to the primary side [406] where switches [404] and [405] are now turned off and act as diodes (through the body diode of the switch). The combination of these diodes [404] and [405], and the capacitors in the network [403] act as a voltage doubler to produce the desired high voltage, which is filtered and balanced by the networks of [403] and [402].

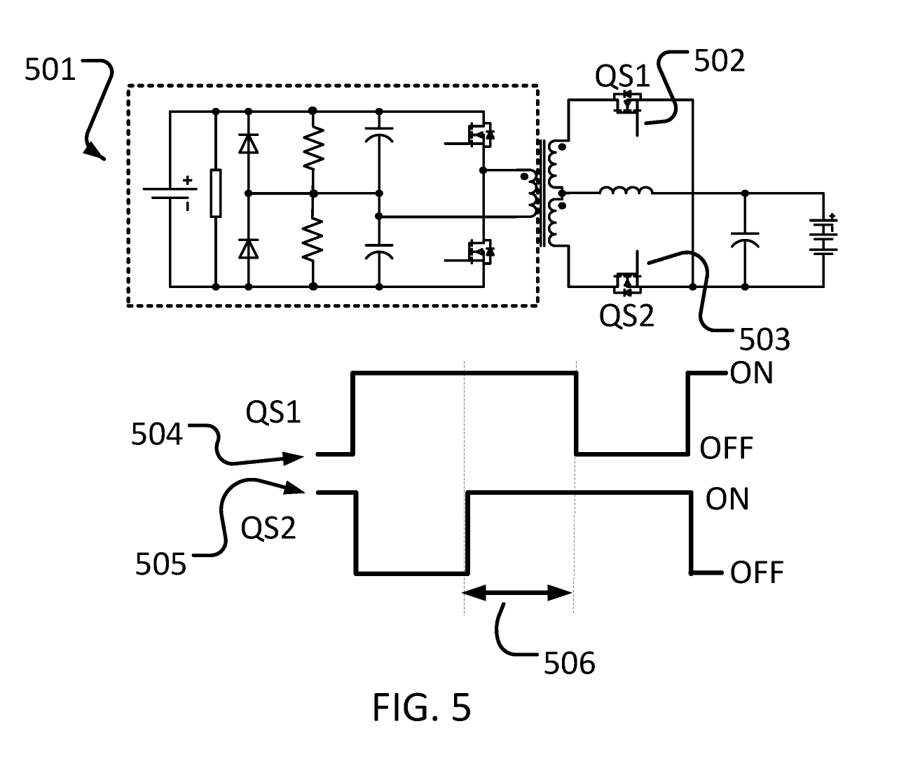

The switching operation of switches [409] and [410] is critical for rapid power flow reversal and for continuously variable voltages. Instead of operating the switches 180 degrees out of phase with each other, the switches' drive signals are overlapped and the degree of overlap is determined by the required voltages and power flow characteristics. FIG. 5 is an illustration of an embodiment of the invention showing the operation of the switches. The waveforms [504] and [505] for the drive signals of [502] and [503] are shown. Switch QS1 [502] is initially off while switch QS2 [503] is on. QS1 then switches on, while QS2 is switched off. At a later time while QS1 is still on, QS2 is turned on, and both switches remain on until QS1 is turned off. The overlap, [506] when both switches are turned on, is varied according to the voltages and power operation of the circuit.

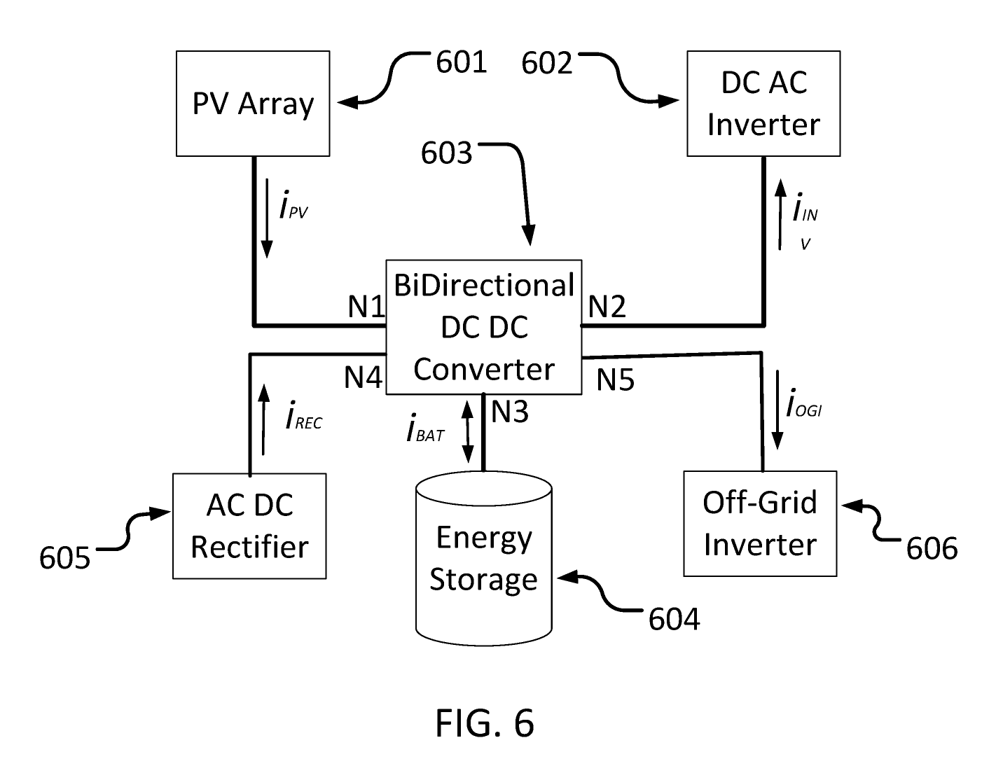

FIG. 6 is another embodiment of the invention wherein additional sources and loads are connected to the same converter [603] to increase functionality beyond simply time shifting of the renewable energy harvested. In this embodiment of the invention, an auxiliary DC power is supplied through a rectifier [605] which is connected to an AC source such as a generator, wind turbine, or utility grid. The DC output of this rectifier is configured to match the primary side voltage of the converter [603]. This provides power and energy when the PV is absent and the energy storage [604] need to be charged. In this embodiment of the invention an auxiliary, off-grid DC AC inverter [606] is connected to provide critical load power supply, whether the utility grid is present or not. This off-grid inverter [606] can be supplied by either the high voltage on the primary side of the converter [603] or the secondary side, low voltage side of the converter [603].

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims:

What is claimed is:

1. An apparatus comprising:
A bidirectional DC DC converter with a first stage configured to receive or deliver energy at one voltage and that is magnetically coupled to a second stage configured to receive or deliver energy at a lower voltage;
A controller that sets the power flow direction either by preconfigured operating parameters or user instructions;
A controller that measures voltage and current at the first stage and configures the power delivery to blend with external sources and loads according to user set configurations;
A controller that measures voltage and current at the second stage and configures the received power to match the desired operating parameters of the energy storage elements;
A controller that controls the time and duration of the delivery of the power from the energy storage element of the second stage to the output terminals of the first stage;

2. The apparatus of claim 1, wherein the switches in the second stage of the bidirectional DC DC converter are operated synchronously to rectify the AC signal received from the magnetically coupling transformer windings.

3. The apparatus of claim 1, wherein the switches in the second stage of the bidirectional DC DC converter are operated in a continuously variable overlapping pattern to energize the windings in the magnetically coupling transformer in order to control the circuit's voltage gain.

4. The apparatus of claim 1, wherein a second port is connected to the first stage of the bidirectional DC DC converter to provide a secondary source of DC power for either energy storage or delivery to a load.

5. The apparatus of claim 1, wherein a second port is connected to the second stage of the bidirectional DC DC converter to deliver DC power to a connected load.

6. The apparatus of claim 1, wherein a data communications port connected to the controller of the bidirectional DC DC converter provides a user interface to set the operating parameters of the converter.

7. The apparatus of claim 1, wherein a signal port is connected to the controller of the bidirectional DC DC converter to receive data from the energy storage system.

8. The bidirectional DC DC converter of claim 2, wherein the switches are Silicon Carbide (SiC) transistors.

9. The bidirectional DC DC converter of claim 2, wherein the switches are Gallium Nitride (GaN) transistors.
